(19) United States
(12) Patent Application Publication
(10) Pub. No.: US 2002/0069098 A1
(43) Pub. Date: Jun. 6, 2002

(54) System and method for protecting proprietary material on computer networks

(75) Inventor: Christopher Schmidt, Alexandria, VA (US)

Correspondence Address: GREENBERG-TRAURIG, 1750 TYSONS BOULEVARD, 12TH FLOOR, MCLEAN, VA, 22102, US

(73) Assignee: Infoseer, Inc.

(21) Appl. No.: 09/942,927

(22) Filed: Aug. 31, 2001

Related U.S. Application Data
(60) Provisional application No. 60/229,037, filed on Aug. 31, 2000.
(60) Provisional application No. 60/229,040, filed on Aug. 31, 2000.
(60) Provisional application No. 60/229,038, filed on Aug. 31, 2000.
(60) Provisional application No. 60/229,039, filed on Aug. 31, 2000.
(60) Provisional application No. 60/248,283, filed on Nov. 14, 2000.

(51) Int. Cl. G06F 15/173; G06F 17/60

(52) U.S. Cl. 705/7; 709/224

(57) ABSTRACT

A method of controlling transfer of proprietary content on a computer network including the steps of identifying computers offering proprietary content on the computer network, identifying network addresses corresponding to the computers, identifying physical addresses corresponding to the network addresses and communicating a warning notice to at least one physical address.

This application claims priority to U.S. Provisional Patent Application No. 60/229,037, filed Aug. 31, 2000, U.S. Provisional Patent Application No. 60/229,040, filed Aug. 31, 2000, U.S. Provisional Patent Application No. 60/229,038, filed Aug. 31, 2000, U.S. Provisional Patent Application No. 60/229,039, filed Aug. 31, 2000, U.S. Provisional Patent Application No. 60/248,283, filed Nov. 14, 2000, U.S. Provisional Patent Application No. ______, entitled SYSTEM AND METHODS FOR INCORPORATING CONTENT INTELLIGENCE INTO NETWORK SWITCHING, FIREWALL, ROUTING AND OTHER INFRASTRUCTURE EQUIPMENT, filed Aug. 23, 2001, and U.S. Provisional Patent Application No. ______, entitled SYSTEM AND METHODS FOR POSITIVE IDENTIFICATION AND CORRECTION OF FILES AND FILE COMPONENTS, filed Aug. 23, 2001, which are all incorporated by reference as if fully recited herein in their entirety.

This application is related to commonly owned U.S. patent application Ser. No. ______, filed on Aug. 31, 2001, entitled SYSTEM AND METHOD FOR TRACKING AND PREVENTING ILLEGAL DISTRIBUTION OF PROPRIETARY MATERIAL OVER COMPUTER NETWORKS, commonly owned U.S. patent application Ser. No. ______, filed on Aug. 31, 2001, entitled SYSTEM AND METHOD FOR POSITIVE IDENTIFICATION OF ELECTRONIC FILES, and commonly owned U.S. patent application Ser. No. ______, filed on Aug. 31, 2001, entitled SYSTEM AND METHOD FOR CONTROLLING FILE DISTRIBUTION AND TRANSFER ON A COMPUTER, which are all incorporated by reference as if fully recited herein in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of computer software and the Internet, and, more particularly, to a system and method for searching, finding and analyzing content and private information on computer networks in order to protect proprietary material.

### BACKGROUND OF THE INVENTION

There is currently a problem with copyrighted and other proprietary material being freely distributed on the Internet. Content and private information is being distributed without its owners receiving compensation from proprietors of software applications, through companies and web sites such as Napster, Gnutella, MP3.com, Scour, I-Mesh and many other means of peer-to-peer communications (which are conceptually similar to Napster or Gnutella, where people communicate directly from computer to computer to transfer files, rather than from a central server), as well as illegal web sites. Currently nothing is in place that can protect industry interests when their content is pirated, and their copyrights are infringed.

### SUMMARY OF THE INVENTION

Accordingly, the present invention is directed to a system and method for protecting proprietary material on computer networks that substantially obviates one or more of the problems due to limitations and disadvantages of the related art.

An object of the present invention is to provide a way of automatically identifying sources of proprietary content on a computer network and assisting the proprietary content owner in protecting its intellectual property.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a method of controlling transfer of proprietary content on a computer network including the steps of identifying computers offering proprietary content on the computer network, identifying network addresses corresponding to the computers, identifying physical addresses corresponding to the network addresses and communicating a warning notice to at least one physical address.

In another aspect of the present invention there is provided a method of identifying violators of intellectual property rights on a computer network including the steps of continuously identifying computers offering proprietary content on the computer network, identifying network addresses corresponding to the computers, and storing the network addresses in an updatable network address database.

In another aspect of the present invention there is provided a system for controlling transfer of proprietary content including means for identifying computers offering proprietary content on a network, means for identifying network addresses corresponding to the computers, means for identifying physical addresses corresponding to the network addresses, and means for communicating a warning notice to at least one physical address.

In another aspect of the present invention there is provided a system for controlling transfer of proprietary content comprising means for identifying computers offering proprietary content on a network, means for identifying network addresses corresponding to the computers, means for identifying physical addresses corresponding to the network addresses; and means for communicating a warning notice to at least one physical address.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the integration of the Data Collector (InfoWatch), File Identification (InfoTag), Database (InfoMart) and Router/Firewall (InfoGuard);

FIG. 2 is a block diagram illustrating the main components of the Data Collectors (InfoWatch) and the interactions of other InfoSeer Control Systems;

FIG. 3 is a block diagram illustrating how data is collected through peer-to-peer networks;

FIGS. 4 and 5 are block diagrams illustrating data collectors for web sites and FTP sites;

FIGS. 6 and 7 illustrate the function of a preferred embodiment in flow chart form; and

FIG. 8 is a block schematic diagram explaining the InfoWatch conversion process.

### DETAILED DESCRIPTION OF THE PREFERRED EMBODIMENTS

Reference will now be made in detail to the preferred embodiments of the present invention, examples of which are illustrated in the accompanying drawings.

The invention provides a system and method that will search and find copyrighted content and other privately owned information on the Internet. The search results are analyzed to determine if there is copyrighted material or private information that is being pirated on computer networks, such as the Internet.

For the sake of consistent terminology, the following convention will be used:

A unique identifier (hereinafter, tag, InfoTag, or InfoScan identifier) is created for each file, using sophisticated digital signal processing techniques. The InfoTag, apart from accurately identifying the file, is used to control content to ensure that it moves across the network infrastructure consistent with the owner's requirements. The InfoTag is not embedded in the files or the header, thereby making it literally undetectable. In the case of music, the InfoTag may be created based on, for example, the first 30 seconds of the song. The InfoTag may also contain such information as IP address of the source of the file, spectral information about the file, owner of the file, owner-defined rules associated with the file, title of work, etc.

InfoMart is an information storage system, normally in the form of a database. It maintains all the identifiers (tags) and rules associated with the protected files. This data can be used for other value-added marketing and strategic planning purposes. Using the DNS model, the InfoMart database can be propagated to ISP's on a routine basis, updating their local versions of the InfoMart database.

InfoWatch collects information about content files available on the Internet using a sophisticated information flow monitoring system. InfoWatch searches to find protected content distributed throughout the Internet. After the information is collected, the content is filtered to provide the content owners with an accurate profile of filesharing activities.

InfoGuard is the data sentinel. It works within the network infrastructure (typically implemented within a router or a switch, although other implementations are possible, such as server-based, as well as all-hardware, or all-software, or all-firmware, or a mix thereof) to secure intellectual property. InfoGuard can send e-mail alerts to copyright violators, embed verbal and visual advertisements into the inappropriately distributed content, inject noise into the pirated content, or stop the flow of the content all together. InfoGuard may be thought of a type of intelligent firewall, an intelligent router, or an intelligent switch, in that it blocks some content files from being transferred, while permitting others to pass, or to pass with alterations/edits. InfoGuard can identify the type of file and identity of the file by creating a tag for it, and comparing the tag to a database of tags (InfoMart database).

Additionally, the following two appendices are incorporated by reference as if fully recited herein: APPENDIX 1, entitled White Paper: InfoSeer Audio Scan Techniques, and APPENDIX 2, entitled InfoSeer Inc. Response to RIAA/IFPI Request for Information on Audio Fingerprinting Technologies, July 2001.

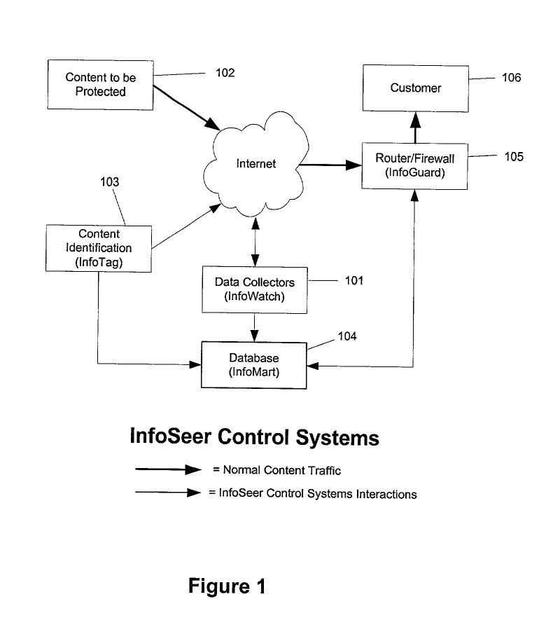

A system and method for protecting copyrighted and privately owned content and private information on computer networks is described, wherein the system can search and find privately owned information on computer networks, and store the results for analysis. The results are analyzed to determine if privately owned material is being pirated and distributed via a computer network. As shown in FIG. 1, the system includes Data Collectors 101 integrated to search and gather information about pirated content 102. The Data Collectors 101 will work in peer-to-peer networks (such as Napster and Gnutella), web sites and FTP sites collecting information about the users and privately owned and copyrighted content and information. The data and information collected by the Data Collectors 101 is then synthesized by the conversion component of the Data Collectors 101 for later use in protecting privately owned or copyrighted material.

The following is a list of some of the information to be gathered: content files, usernames, IP addresses, ports, location, connection speed, content specific information (i.e., Bit Rate and Frequency of an MP3 file) and other pertinent information. Intelligent data collectors 101 search web sites like Scour, MP3.com, as well as illegal sites, to identify content files and associated IP addresses.

After the information is gathered, the content 102 and the related information is synthesized by the conversion component of the Data Collectors 101. It runs file content identification software (InfoTag) against the content 102 and checks to see if an identification already exists in a InfoMart Database 104. If it does not reside in the database 104, the content 102 can be manually validated to verify that it has a copyright and should be protected. The IP addresses and usernames are also checked and any duplicates are removed from the list. Once this information is synthesized, the IP addresses and ports are pushed to the InfoMart Database 104 for storage. The IP Addresses and ports are then used by the InfoGuard Router/Firewall 105 to protect copyrighted content (or other proprietary content) on the Internet by logging, stopping or replacing the content during its transfer. Any copyrighted content not contained in the database 104 will be pushed to a main repository that is used to monitor the Internet for copyrighted media infringement. See FIG. 1 for a diagram of the Data Collector (InfoWatch) 101, File Identification (InfoTag) 103, InfoMart Database 104 and InfoGuard Router/Firewall 105.

The preferred embodiment, as will be described below with reference to the figures, provides a system and method for searching for, finding, and analyzing content and privately owned and copyrighted material on computer networks. The data produced can be used to protect copyrighted material.

For the Data Collectors 101 residing on the peer-to-peer network, web sites, FTP sites or the like, the first step is to gather data from the peer-to-peer networks, web sites, FTP sites and the like, where copyrighted content 102 is freely distributed. FIG. 1 illustrates the placement of Data Collector's 101 on a computer network, such as the Internet.

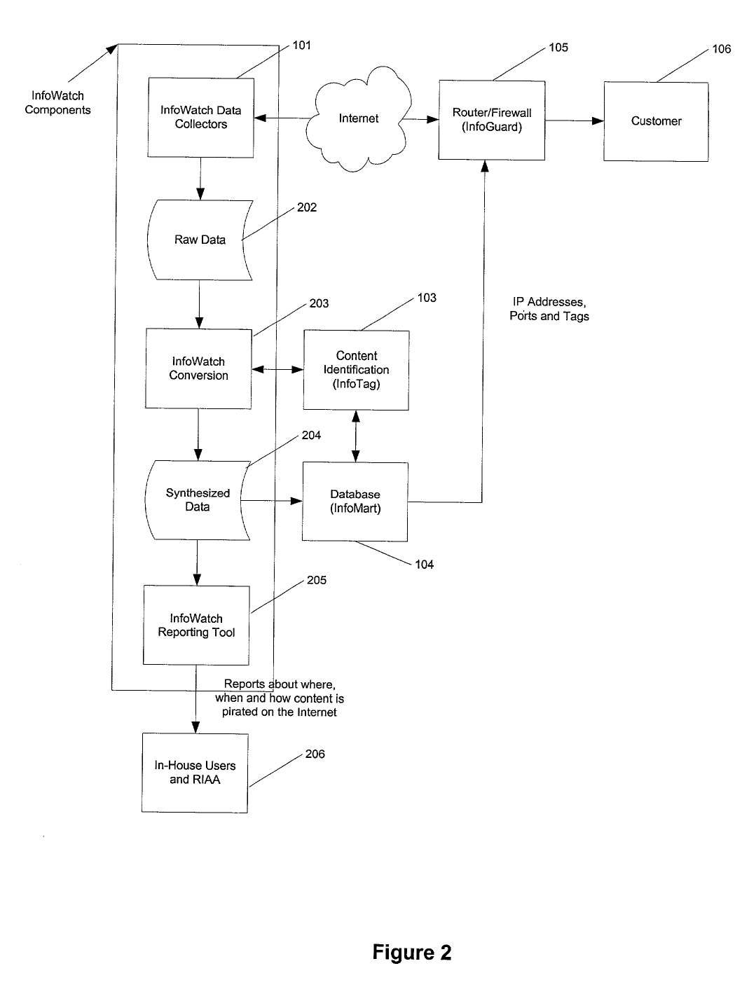

With reference to FIGS. 1 and 2, it is an ongoing process to have the most current information about copyrighted content 102 on the Internet and computer networks. The data collection algorithm will constantly run and gather data. Data gathered includes IP Addresses, Ports, Usernames (when applicable), Content Location, Content Title and the actual content. The actual content is downloaded from the location at which it is found. All of this information is then stored in Raw Data Storage 202, where it awaits processing.

The second step is for the InfoWatch conversion component 203 to convert the raw data 202 into usable synthesized data. In the preferred embodiment, one instance of the conversion process is to convert the portion of the raw data 203 of IP Addresses and ports to a condensed unique list. The actual content 102 is then passed over to InfoTag 103, which associates the content 102 with a content identification tag. The tag is then compared to the InfoMart Database 104 to positively identify the content 102 as copyrighted. Once it is positively identified, the title of the content is stored in the Synthesized data 204. Next, the InfoWatch Filters 205 provide content providers with information pertaining to when and where the piracy is occurring, and who is pirating the privately owned or copyrighted material 102. The synthesized data 204 provided to the InfoMart Database 104 will also be disseminated to the various InfoGuard Router/Firewall 105 agents, present on the network, for the agents to analyze network traffic to find privately owned or copyrighted material 102, and take action according to instructions of the content owner 206 if such privately owned and copyrighted material is found.

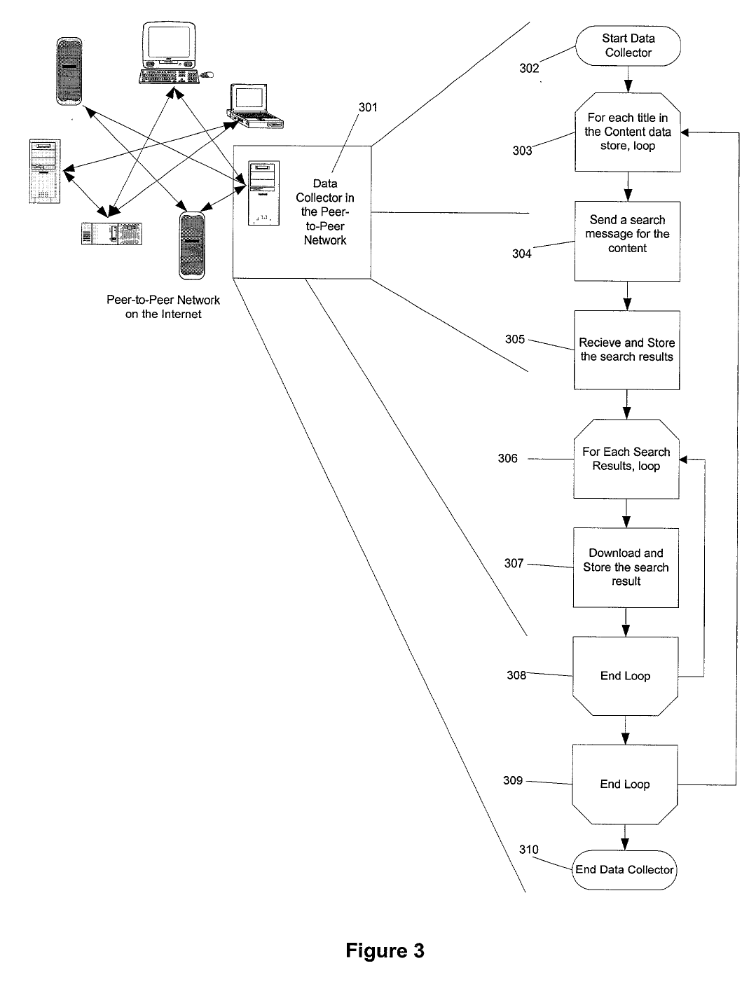

FIG. 3 shows additional detail of how data is collected through peer-to-peer networks. The Data Collector 101 will assume a position in the peer-to-peer network, acting as servants do in peer-to-peer networks (301). This way the Data Collector 101 can ask for and receive data passed around on the network. This data includes at least IP Addresses, ports, content titles, content locations, connection speeds, content-specific information and the actual content. Note that asking for and receiving of data is non-intrusive and does not stop traffic flow in the peer-to-peer network. The data is gathered by searching in the peer-to-peer network for the privately owned or copyrighted content by looping through a copyrighted data store containing titles of the copyrighted content. Once the search results are found, they are stored in the Raw Data Storage 202. Then the content is downloaded from the peer-to-peer network and stored in the Raw Data Storage 202. Data Collectors 101 have been written for the peer-to-peer networks of Napster, OpenNap, FTP and Gnutella and more data collectors for other peer-to-peer networks are in the works. It should be noted that the methodology for identifying content on the majority of peer-to-peer file sharing mechanisms, like Gnutella, is very similar.

As may be frrther seen from FIG. 3, once the Data Collector 101 is started, normally it loops continuously (302). For each title in the content 102, the data is stored (303). The Data Collector 101, acting as a servant in a peer-to-peer file sharing network, sends out a search message, searching for the content (304). When a response is received by the Data Collector 101, the response (i.e. the search results) is stored (305). For each result, the Data Collector 101 downloads and stores the content (307). The loop (308) is performed until all content from the search results is downloaded. The loop (309) continues until all the titles are searched for. The Data Collector may optionally be ended, at the discretion of the manager of the Data Collection Process (310).

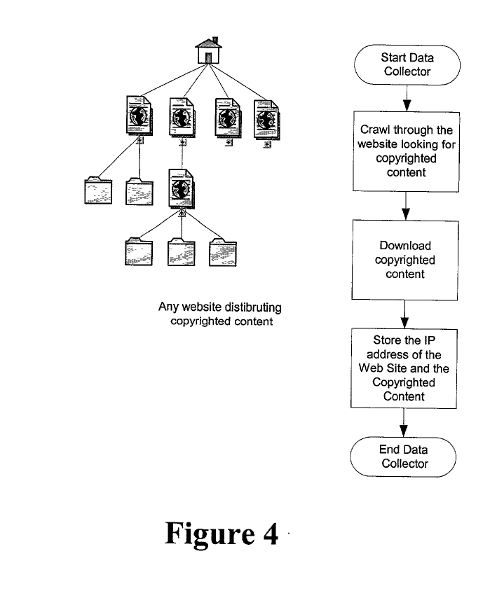

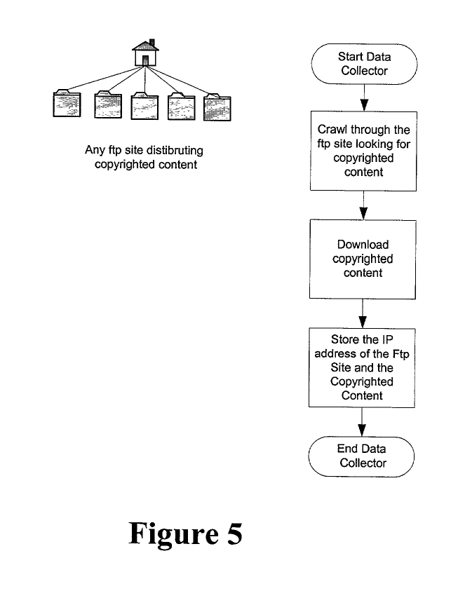

FIGS. 4 and 5 are schematic block diagrams illustrating Data Collectors 101 for web sites and FTP sites. The web site or FTP site is “crawled” and searched for copyrighted content 102. Once the content 102 is found, it is downloaded and stored with the IP address, port, content location, content title and actual content in the Raw Data Storage. The various Data Collectors 101 will always be evolving to meet the need to collect information about copyrighted material 102 on computer networks such as the Internet. Once the data has been collected and placed in the Raw Data Storage 202 (see FIG. 2), it must be synthesized/converted into useful information. The conversion is done by a conversion component 203 (“InfoWatch conversion component” 203).

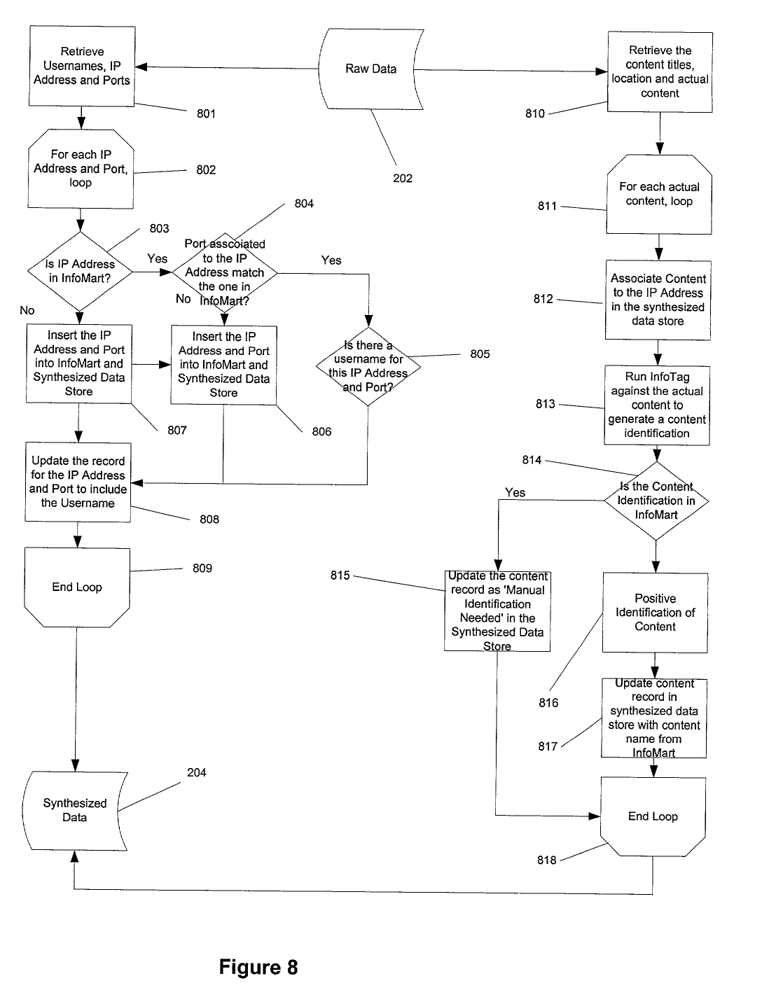

FIG. 8 is a block schematic diagram explaining the conversion process. Initially, the EP addresses and ports must be converted into a unique list by eliminating duplicates of the same IP addresses and ports. The IP addresses and ports are stored in the InfoMart Database 104 and the Synthesized Data storage 204 (see FIG. 2). If a usemame can be associated with the IP address, then the Synthesized Data store is updated with the usemame. The content title, location and actual content is associated to IP addresses. Then InfoTag 103 generates a content identification of the actual content 102 and compares the identification to data in the InfoMart 104. If a match is found, then the Synthesized Data store 204 is updated with the actual name according to the InfoMart Database 104. If a match is not found, then the content 101 is marked as “Manual Identification Needed” indicating that there is a need for a human to analyze the content to determine if it is privately owned or copyrighted material, to decide if it is copyrighted material that should have matched content in the InfoMart Database 104. This step helps determine if the copyrighted content 102 is being modified to pass the InfoGuard Router/Firewall 105 undetected.

As may be further seen from FIG. 8, the raw data 202 may be used to retrieve user names, IP addresses and ports (801). The next step is to determine what to do with each IP address and port (902). If the IP address is in the InfoMart Database 104 (803) then the conversation component determines if the port associated with the IP address matches the one in the InfoMart Database (804). If yes, then the system determines whether there is a corresponding user name for this IP address and port (805). If no, then the system will insert the IP address and port into the InfoMart Database 104 and the synthesized data storage 204 (806). If the IP address is not in the InfoMart Database, then the conversation component will insert the IP address and port into the InfoMart Database 104 and the Synthesized Data Storage 204 (807). After steps 807, 806, and 805 the record in the InfoMart Database 104 will be updated for the IP address and the port, to also include the user name (808). The loop is then ended (809), and the synthesized data is updated.

As may be further seen from FIG. 8, the other task that may be performed with the raw data 202 is to retrieve the contents titles, location, and actual content (810). For each actual content, a loop will be performed (811). The content will be associated with the IP address in the Synthesized Data Storage 204 (812). The InfoTag algorithm will be run against the actual content to generate a content identification tag (813). Next, the system will determine if the content identification tag is in the InfoMart Database 104 (814). If the answer is yes, then the content record will be updated as manual identification needed in the synthesized data storage 204 (815). If the answer is no, then a positive identification of the content 102 is needed (816). The content record in the synthesized data storage 204 will be updated with content named from the InfoMart Database 104 (817). The loop for each actual content is then ended (818). At that point, the synthesized data storage 204 is up to date, as of that moment.

Another component is the Filters 205. The Filters component 205 is a combination of a web site and a desktop application that allows content providers 206 to quantify the problem of freely distributed, privately owned and copyrighted material on a computer network and find out when and where the piracy is occurring, and who is pirating the privately owned or copyrighted material on the computer network. These reports, produced by the Filters 205, will provide users with information regarding DNS lookups of the IP addresses, street addresses of the location of the computers used to freely distribute privately owned and copyrighted content, listings of copyrighted content by IP address, matches against the InfoMart Database 104, customizable reports of the synthesized data, identification of the “worst offenders,” identification of the most popular content that is being pirated (including, for example, location of the piracy, identity of pirates), etc.

In the preferred embodiment of the invention, the following elements are present:

1. Data Collectors 101 that monitor peer-to-peer networks, web sites, centralized servers, gopher sites, Usenet, email sites and FTP sites for proprietary content 102.

2. Absolute positive identification of proprietary content 102.

3. Collection of IP Addresses and ports to assist the InfoGuard Router/Firewall 105 in applying rules to proprietary content 102 as it is transferred over the Internet, WAN's and LAN's.

4. An ability to search and identify the illegal transfer of proprietary content 102 within the Internet, WAN's and LAN's.

The Cease and Desist Notification Process

The cease and desist process is a workflow tool that aids a legal team in determining offenders, building a case, sending cease and desist letters to the offenders based on the DCMA law.

An offender is determined as the owner of the computer running a file sharing servant or client on. In the internal system of InfoWatch, an offender is defmed by the IP address, port and type of file sharing servant or client (i.e. Napster, Gnutella, or Web Site).

For example, there could be at least three types of users of InfoWatch: Investigator, Paralegal and Reviewer. The following describes their roles in the workflow.

Investigator: An Investigator searches through the list of offenders to determine who should have action taken against them. Once it is determined that an offender should have action taken against him/her, the investigator starts the case by clicking on the ‘Take Action’ button. This marks the offender for ‘Paralegal Assignment’.

Paralegal: The Paralegal can do anything that the Investigator can do. The Paralegal is able to determine new cases that have been started by the investigator(s). The paralegal chooses his/her cases to work on. Once the paralegal chooses a case to work on, he/she is presented with a list of email addresses of the ISP, Corporation or University. Since the name of the person who owns the computer running a file sharing servant or client cannot always be determined, the email must be sent to the ISP, Corporation, or University which owns the IP address. This is why the Paralegal selects the email address of the ISP, Corporation or University. Once the email is selected, the Paralegal can choose which Artist will be in the letter by selecting each individual artist displayed.

Now, the case letter is generated. The Paralegal can modify the email address, artists and case letter until the offender is marked for review by the reviewer or sent to the selected email address. If the Paralegal is not ready to email the case or mark it for the Reviewer, he/she can save the case for later modification.

Reviewer: The Reviewer can do anything the Paralegal can do. The Reviewer reviews cases by the Paralegal. He tweaks the cease and desists letters as well as the email address and selected artists. He has the choice of sending a case or saving the case for later editing.

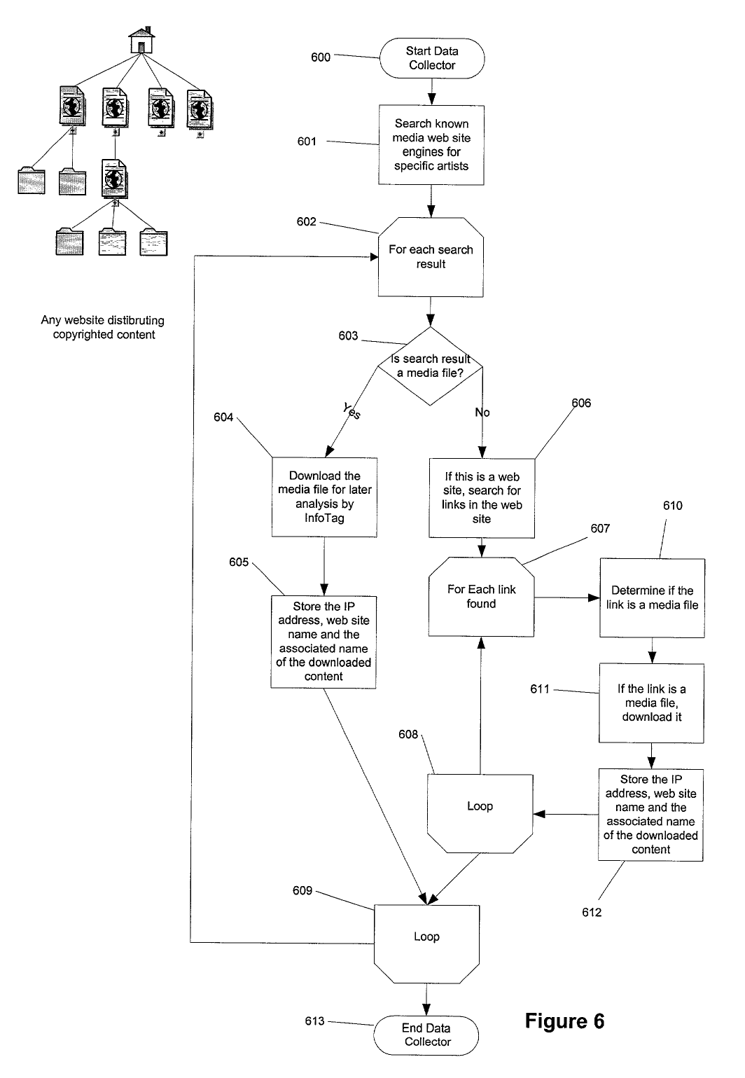

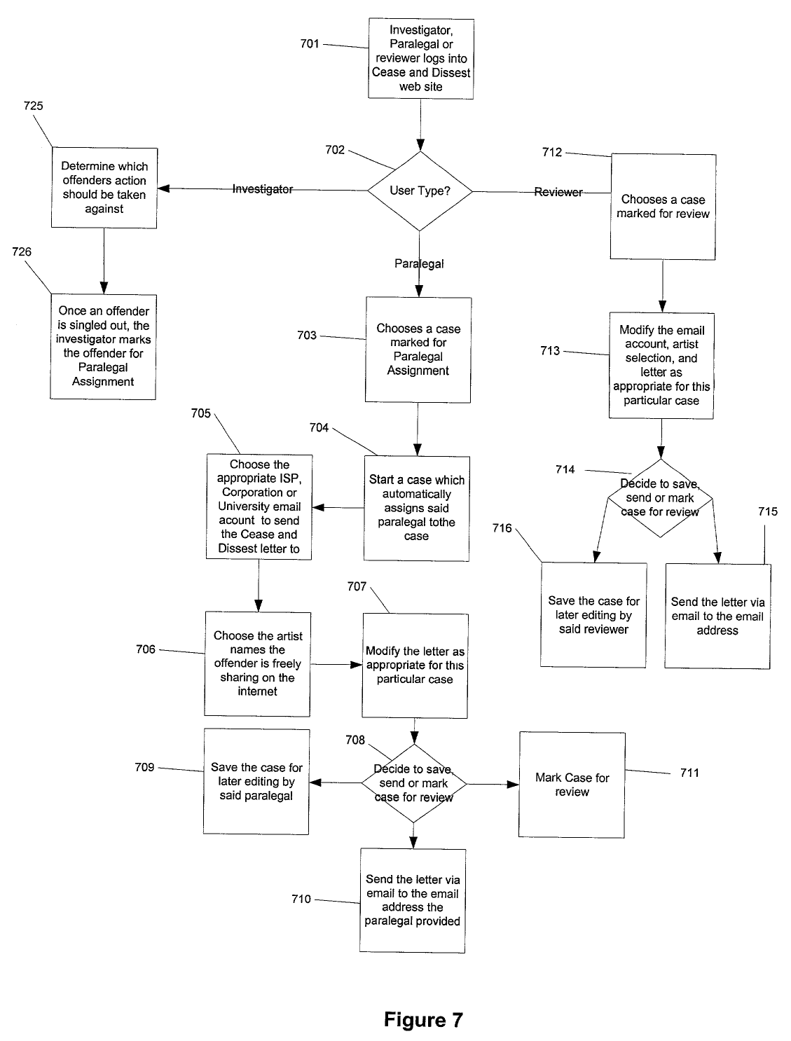

The process of sending out cease and desist letters is further illustrated in FIGS. 6 and 7. As may be seen from FIG. 6, the Data Collector 101 is started (600). The Data Collector 101 then searches known media web site engines for specific artists (601), for the case where content involving music is at issue. Note that a similar process can be performed for other types of proprietary content such as movies; publishing content; books; virus detection; private health and pharmaceutical records; video games; confidential personal documents, such as wills and financial records; images, including digital pictures and CAD drawings; trade secrets, such as recipes, formulas, and customer lists; and even confidential corporate documents, such as patent applications, etc..

The Data Collector 101 then determines if any search results come back (602). The Data Collector 101 then asks if the search result is a media file (603). If this is a website, the Data Collector will search for links on the website (606). For each link found (607), the Data Collector 101 will determine if the link is a media file (610). If the link is a media file (610), the Data Collector 101 will download it (611). The Data Collector 101 will then store the IP address, the website name, and information associated with the downloaded content 102 (612). Next (608) the Data Collector 101 will either loop back to previous step 607, or will go on to the outer loop (609). In the event that the Data Collector 101 determines that the search result is a media file, the Data Collector 101 will download the media file for later analysis by InfoTag 103 (604). The Data Collector 101 will then store the IP address, the website name, and information associated with the downloaded content 102 (605). The Data Collector 101 will then go on to the outer loop (609). If other search results remain to be analyzed, the Data Collector 101 then goes back to step 602. Otherwise, the user may optionally terminate the running of the Data Collector 101 (613).

As further illustrated in FIG. 7, the process of sending out cease and desist warning (e.g., a letter) starts out with an investigator, paralegal, or reviewer logging into a cease and desist website (701). Depending on the user type (702), if the user is a paralegal, the paralegal would choose a case that is marked for paralegal assignment (703). The paralegal would then start a case, which automatically assigns this paralegal to the particular case (704). The paralegal would then choose an appropriate ISP, a corporation or a university e-mail account to send the cease and desist letter to (705). The paralegal would then choose the artist names that the offender is freely sharing on the internet (706). The paralegal would then modify the letter as appropriate for a particular case (707). The paralegal would then decide whether to save the letter, send the letter or mark the case for review (708). In the case of a “save,” the case is saved for later editing by the paralegal (709). If the decision is to “send,” the letter (or notice) is sent by e-mail or regular mail to the address that the paralegal has (710). As a final alternative, the case can be marked for further review (711).

In the event that the user is an investigator, the investigator would determine which offender's action should be taken against (717). Once an offender is singled out, the investigator marks the offender for paralegal assignment (718).

In the event that the user is a reviewer, the reviewer will choose a case marked for review (712). The reviewer will then modify the e-mail account, artist selection, and letter as appropriate for this particular case (713). The reviewer will then decide whether the case should be saved, sent, or marked for further review (714). The reviewer can save the case for later editing by the reviewer (716) or send the letter by e-mail or regular mail to the available address (715).

Thus, with all of the above components (InfoWatch, InfoGuard, InfoTag and InfoMart) of the system working together, piracy of digital content on the Internet, WAN's and LAN's can be controlled.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

[image]

[image]

[image]

[image]

[image]

[image]

[image]

[image]

[image]

[image]

[image]

[image]

[image]

[image]

[image]

What is claimed is:

1. A method of controlling transfer of proprietary content on a computer network comprising the steps of:
identifying computers offering proprietary content on the computer network;
identifying network addresses corresponding to the computers;
identifying physical addresses corresponding to the network addresses; and
communicating a warning notice to at least one physical address.

2. The method of claim 1, further including the step of generating a tag corresponding to the proprietary content.

3. The method of claim 2, further including the step of comparing the tag to other tags in a database of tags.

4. The method of claim 2, wherein the tag includes spectral information corresponding to the proprietary content.

5. The method of claim 1, further including the step of identifying owners of the network addresses.

6. The method of claim 1, further including the step of storing the network addresses in a database of addresses.

7. The method of claim 1, further including the step of removing duplicate network addresses from the database of addresses.

8. The method of claim 1, wherein the proprietary content includes music.

9. The method of claim 1, wherein the proprietary content includes movie.

10. The method of claim 1, wherein the proprietary content includes at least a portion of a book.

11. The method of claim 1, wherein the proprietary content includes an image.

12. The method of claim 1, wherein the warning notice is a cease and desist letter.

13. The method of claim 1, wherein the warning notice is sent by mail.

14. The method of claim 1, wherein the warning notice is sent by e-mail.

15. The method of claim 1, wherein the network is the Internet.

16. The method of claim 1, wherein the computers are part of a peer-to-peer file sharing network.

17. A method of identifying violators of intellectual property rights on a computer network comprising the steps of:
continuously identifying computers offering proprietary content on the computer network;
identifying network addresses corresponding to the computers; and
storing the network addresses in an updatable network address database.

18. The method of claim 17, further including the step of generating a tag corresponding to the proprietary content.

19. The method of claim 18, further including the step of comparing the tag to other tags in a tag database.

20. The method of claim 18, wherein the tag includes spectral information corresponding to the proprietary content.

21. The method of claim 17, fuirther including the step of identifying owners of the network addresses.

22. The method of claim 17, further including the step of removing duplicate network addresses from the network address database.

23. The method of claim 17, wherein the proprietary content includes music.

24. The method of claim 17, wherein the proprietary content includes a movie.

25. The method of claim 17, wherein the proprietary content includes at least a portion of a book.

26. The method of claim 17, wherein the proprietary content includes an image.

27. The method of claim 17, wherein the warning notice is a cease and desist letter.

28. The method of claim 17, wherein the warning notice is sent by mail.

29. The method of claim 17, wherein the warning notice is sent by e-mail.

30. The method of claim 17, wherein the network is the Internet.

31. The method of claim 17, wherein the computers are part of a peer-to-peer file sharing network.

32. A system for controlling transfer of proprietary content comprising:
means for identifying computers offering proprietary content on a network;
means for identifying network addresses corresponding to the computers;
means for identifying physical addresses corresponding to the network addresses; and
means for communicating a warning notice to at least one physical address.

33. The system of claim 32, further including means for generating a tag corresponding to the proprietary content.

34. The system of claim 33, further including means for comparing the tag to other tags in a database of tags.

35. The system of claim 33, wherein the tag includes spectral information corresponding to the proprietary content.

36. The system of claim 32, further including means for identifying user names corresponding to the computers.

37. The system of claim 32, further including means for storing the network addresses in a database of addresses.

38. The system of claim 32, further including means for removing duplicate network addresses from the database of addresses.

39. The system of claim 32, wherein the proprietary content includes music.

40. The system of claim 32 wherein the proprietary content includes a movie.

41. The system of claim 32, wherein the proprietary content includes at least a portion of a book.

42. The system of claim 32, wherein the proprietary content includes an image.

43. The system of claim 32, wherein the warning notice is a cease and desist letter.

44. The system of claim 32, wherein the warning notice is sent by mail.

45. The system of claim 32, wherein the warning notice is sent by e-mail.

46. The system of claim 32, wherein the network is the Internet.

47. The system of claim 32, wherein the computers are part of a peer-to-peer file sharing network.

48. A method of identifying violators of intellectual property rights comprising:
means for continuously identifying computers offering proprietary content on a network;
means for identifying network addresses corresponding to the computers;
means for storing the network addresses in an updatable network address database.

49. The system of claim 48, further including means for generating a tag corresponding to the proprietary content.

50. The system of claim 49, further including means for comparing the tag to other tags in a tag database.

51. The system of claim 49, wherein the tag includes spectral information corresponding to the content.

52. The system of claim 48, further including means for identifying user names corresponding to the computers.

53. The system of claim 48, further including means for removing duplicate network addresses from the network address database.

54. The system of claim 48, wherein the proprietary content includes music.

55. The system of claim 48, wherein the proprietary content includes a movie.

56. The system of claim 48, wherein the proprietary content includes at least a portion of a book.

57. The system of claim 48, wherein the proprietary content includes at least one of an image, music, a movie, publishing content, an executable file, a video game, private health record, a pharmaceutical record, confidential personal documents, a will, a virus, a financial record, a CAD drawing, trade secret information, a customer list, and a confidential corporate document.

58. The system of claim 48, wherein the warning notice is a cease and desist letter.

59. The system of claim 48, wherein the warning notice is sent by mail.

60. The system of claim 48 wherein the warning notice is sent by e-mail.

61. The system of claim 48, wherein the network is the Internet.

62. The system of claim 48, wherein the computers are part of at least one of a peer-to-peer file sharing network, web sites, centralized servers, gopher sites, Usenet, email sites and FTP sites.

63. A computer program product for controlling transfer of proprietary content comprising:
a computer usable medium having computer readable program code means embodied in the computer usable medium for causing an application program to execute on a computer system, the computer readable program code means comprising:
computer readable program code means for identifying computers offering proprietary content on a network;
computer readable program code means for identifying network addresses corresponding to the computers;
computer readable program code means for identifying physical addresses corresponding to the network addresses; and
computer readable program code means for communicating a warning notice to at least one physical address.
